(19) United States
(12) Patent Application Publication
(10) Pub. No.: US 2006/0081551 A1
(43) Pub. Date: Apr. 20, 2006

(54) Nipple assemblies manufactured to fit standard externally-threaded necks of bottles

(76) Inventor: Linda M. Hegg, Seattle, WA (US)

Correspondence Address: PRESTON GATES ELLIS & ROUVELAS MEEDS LLP, 1735 NEW YORK AVENUE, NW, SUITE 500, WASHINGTON, DC, 20006, US

(21) Appl. No.: 10/968,035

(22) Filed: Oct. 20, 2004

(51) Int. Cl. A61J 11/00; A61J 9/00

(52) U.S. Cl. 215/11.1

(57) ABSTRACT

The present invention relates to a nipple assembly comprising a cap portion and a nipple portion wherein the cap portion has sides and a top wherein the sides have an inner surface comprising screw threads and the top has a hole that is smaller than the circumference of the sides and a lip portion extending inwards from the sides towards the center of the cap and wherein the nipple portion comprises a nipple and a base wherein the base fits securely within the hole in said top and the sides of the cap such that the base portion of the nipple mechanically anchors the nipple within the cap and wherein the base mechanically abuts the bottom surface of the lip such that when the cap is screwed onto a standard externally-threaded neck of a bottle containing a comestible liquid the base acts to form a seal between the bottom surface of the cap and the top of the bottle.

### FIELD OF THE INVENTION

The invention generally relates to a nipple assembly manufactured to fit the standard externally-threaded necks of bottles containing comestible liquids. More particularly, the present invention relates to a variety of nipple assemblies manufactured to fit various sizes of the standard externally-threaded necks of bottles containing comestible liquids.

### BACKGROUND OF THE INVENTION

Traditional baby bottles generally have a standard-sized and threaded neck, so that nipples and rings of varying brands can be interchanged. Before traveling or leaving the house, the usual practice is to prepare various bottles having desired contents in advance of the trip, so that the infant may be fed while away from home. Unfortunately, this is inconvenient since space is often at a premium especially when a parent or guardian typically is carrying other baby accessories. Also, the weight of bottles is cumbersome and the contents are often subject to spills, requiring the cleaning of clothes, blankets, and bags. In addition, on longer trips, the contents of such pre-filled bottles are subject to potential spoilage. These scenarios are long-standing complaints of infants' caretakers.

Several devices have attempted to address the described problems associated with traveling with infants. For instance, certain methods and devices allow conventional baby nipples to be attached to standard commercially-available water or juice bottles. These devices allow caretakers to obtain liquids after leaving the house rather than packing them in advance. As examples, U.S. Pat. No. 5,024,341 to Derkerle, shows a nipple adapter for a bottle comprising a screw ring. The adapter utilizes two threaded components, a screw ring and a threaded end-piece adapter for attaching the nipple assembly to the neck of a threaded bottle. This device allows an infant's caretaker to attach a nipple to a non-standard size bottle so that the infant's bottles do not have to be prefilled and transported. U.S. Pat. No. Des. 414,873 to Kwiecinski shows an ornamental scalloped shaped design for an infant nipple adapter system with an external and an internal threaded portion. U.S. Pat. No. 6,354,449 to Smith shows a nipple adapter that provides pre-assembled components so that there is no need for the end user to assemble the miscellaneous components. Likewise, U.S. Pat. No. Des. 459,815 to Pastucha shows a combined baby bottle nipple and bottle cap.

It is an object of the present invention to provide a nipple assembly that is capable of screwing onto a wide variety of standard externally-threaded necks of bottles containing comestible liquids, while retaining the ability of the nipple assembly to prevent the neck or other portion of such bottles from falling into the mouths of infants through the integration of a collar thereon. It is also an object of the present invention to provide an infant-feeding nipple assembly that is versatile, convenient, easy to use, inexpensive, simple in construction, sterile and disposable.

### SUMMARY OF THE INVENTION

The invention presently disclosed greatly simplifies traveling with a baby or infant. It allows caretakers to carry only the simple, disposable nipple assemblies disclosed by the present invention rather than pre-packing and carrying traditionally filled baby bottles. The present invention is preferable to other previously described devices because it is exceedingly versatile, simple, convenient, practical, safe, sterile, inexpensive and disposable. Different embodiments of the invention fit and screw onto a wide variety of the standard externally-threaded necks of bottles containing comestible liquids, thus allowing for numerous feeding options while on the road or at home.

The present invention provides nipple assemblies manufactured to fit and screw onto the standard externally-threaded necks of bottles. Specifically, in one embodiment the invention presently disclosed includes a nipple assembly comprising a cap portion and a nipple portion, wherein the cap portion comprises sides and a top. The sides have an inner surface comprising screw threads, and the top has both a hole that is smaller than the circumference of the sides and a lip portion extending inwards from the sides towards the center of the cap. The nipple portion comprises a nipple and a base wherein the base fits securely within the hole in the top and the sides of the cap such that the base portion of the nipple mechanically anchors the nipple within the cap and wherein the base mechanically abuts the bottom surface of the lip such that when the cap is screwed onto a standard externally-threaded neck of a bottle containing a comestible liquid, the base acts to form a seal between the bottom surface of the lip of the cap and the top of the bottle. The nipple assemblies of the present invention may be manufactured to fit and screw onto standard externally-threaded necks of bottles capable of containing a comestible liquid having a neck diameter selected from the group consisting of 18 mm, 20 mm, 22 mm, 24 mm, 26 mm, 28 mm, 33 mm, 38 mm, 43 mm, 48 mm, 53 mm, 63 mm, 70 mm, 89 mm, and 110 mm.

In another embodiment of the present invention, the nipple assemblies may be manufactured to fit and screw onto standard externally-threaded necks of bottles capable of containing a comestible liquid having a finish number selected from the group consisting of 100, 110, 120, 140, 145, 100, 103, 200, 200A, 400, 410, 415, 425, 430, 435, 444, 445, 450, 455, 460, 470, 480, 485, 490, and 495.

In another particular embodiment, the nipple assemblies of the present invention may include a protrusion extending outwardly from the nipple above the top portion of the lip of the cap, serving to further mechanically anchor the nipple within the cap.

In another embodiment of the present invention, the nipple assemblies may include an outwardly extending collar capable of mechanically preventing the standard externally-threaded neck or other portion of the bottle containing a comestible liquid from falling into a baby's mouth. In another particular embodiment, the outwardly extending collar may be a radially-enlarged annular flange. In another particular embodiment, the outwardly extending collar may have a diameter of at least about 38 millimeters. In yet another particular embodiment, the outwardly extending collar may have a diameter of at least about 40 millimeters. In another particular embodiment of the present invention, the outwardly extending collar may have a diameter of at least about 45 millimeters.

In another embodiment of the present invention, the nipple assemblies may include both a protrusion extending outward from the nipple above the top portion of the lip portion of the cap, thus serving to further mechanically anchor the nipple within the cap, and a collar extending outwardly from the cap wherein this collar is capable of preventing the standard externally-threaded neck or other portion of a bottle containing a comestible liquid from falling into a baby's mouth.

In a further particular embodiment of the present invention, the nipple protrusion previously described may be an enlarged collar capable both of further mechanically anchoring the nipple within the cap and preventing the standard externally-threaded neck or other portion of the bottle containing a comestible liquid from falling into a baby's mouth.

In particular embodiments of the present invention, the collar may extend from the cap of the nipple assembly of the present invention. In one embodiment, this collar extending from the cap may be a radially-enlarged annular flange. In another embodiment, the collar and the cap are molded as one piece during manufacturing. In another particular embodiment, the collar and the cap are held together by frictional forces. In another particular embodiment, the collar may extend outwardly from the top portion of the cap. In another particular embodiment of the present invention, the collar may extend outwardly from the sides of the cap. In yet another particular embodiment, the collar may extend outwardly from the bottom portion of the cap. These varying embodiments of the cap and collar may be included in those nipple assembly embodiments that include or do not include a nipple protrusion above the top portion of the lip of the cap.

In one embodiment of the present invention, the comestible liquid may be water. In another particular embodiment, the comestible liquid may be milk. In another particular embodiment, the comestible liquid may be tea. In yet another embodiment, the comestible liquid may be juice. In another embodiment of the present invention, the comestible liquid may be a sports drink. In another particular embodiment, the comestible liquid may be a soft drink. In yet another particular embodiment of the present invention, the comestible liquid may be a yogurt drink.

In another embodiment of the present invention, the nipple is generally conical-shaped with a flexible tubular body.

In another particular embodiment of the present invention, the nipple and cap are a unitary assembly. In another particular embodiment, the nipple and cap are bound together as a unitary assembly through the use of a glue or adhesive. In another particular embodiment, the glue or adhesive used to bind the nipple and cap are non-toxic. In another particular embodiment of the present invention, the nipple and cap are bound together by heat sealing. In yet another embodiment, the nipple and cap are bonded together during the hardening of materials during manufacturing. In another embodiment, the nipple and cap are sold as a unitary assembly that is held together by mechanical and frictional forces. In this embodiment, the nipple and cap may be separated without damaging either.

In another embodiment of the present invention, any additional parts or functions not previously mentioned are expressly excluded.

### BRIEF DESCRIPTION OF THE DRAWINGS

In the accompanying drawings:

FIG. 1 is a cross-sectional view of one embodiment of the nipple assembly of the instant invention.

FIG. 2 is a cross-sectional view of an alternative embodiment of the nipple assembly of the instant invention.

FIG. 3 is a cross-sectional view of another alternative embodiment of the nipple assembly of the instant invention.

FIG. 4 is a cross-sectional view of another alternative embodiment of the nipple assembly of the instant invention.

FIG. 5 is a cross-sectional view of yet another alternative embodiment of the nipple assembly of the instant invention.

FIG. 6 is a cross-sectional view of yet another alternative embodiment of the nipple assembly of the instant invention.

FIG. 7 is a cross-sectional view of another alternative embodiment of the nipple assembly of the instant invention.

### DETAILED DESCRIPTION OF PREFERRED EMBODIMENTS

It is to be understood that the present invention is not limited to the particular embodiments, materials, and examples described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a nipple” or “a nipple assembly” is a reference to one or more nipples or nipple assemblies and includes equivalents thereof known to those skilled in the art and so forth.

Unless defined otherwise, all technical terms used herein have the same meanings as commonly understood by one of ordinary skill in the art to which this invention belongs. Specific methods, devices, and materials are described, although any methods and materials similar or equivalent to those described herein can be used in the practice or testing of the present invention.

The phrases “comestible liquid” or “comestible liquids” mean any liquid that is intended for human consumption. In terms of the present invention, the comestible liquid is packaged in a bottle having a standard externally-threaded neck. It is preferred that the liquid be suitable for consumption by a baby or infant. Therefore, while alcohols and other adult beverages are not excluded from the definition of “comestible liquid” or “comestible liquids,” they are not preferred. Examples of comestible liquids include waters, such as, for example and without limitation, all bottled waters, including those described as, for example and without limitation, spring waters, glacier waters, mineral waters, carbonated and non-carbonated waters, and flavored waters. Examples of such waters include, for example and without limitation, those sold by or under the name, Crystal Spring®, Arctic Glacier®, Calistoga®, Dannon®, Evian®, Saratoga Spring®, Hydra8™, Aquafina®, Crystal Geyser®, Arrowhead®, Fruit₂O®, Perrier®, and Alhambra®; any flavor or type of juice drink, such as for example and without limitation, apple, grape, orange, or berry juices sold by or under the name, for example and without limitation, Snapple®, Ocean Spray®, Sunkist®, Tropicana®, Minute Maid®, Welch's®, Sunny Delight®, Florida's Natural®, Mott's®, Nantucket Nectars®, and Tree Top®; sports drinks, such as those sold by or under the name, for example and without limitation, Powerade®, All Sport®, Gatorade®, and SoBe Sport™ in either isotonic, hypotonic or hypertonic forms; milk products, such as, for example and without limitation, soy milk, cow milk, goat milk, whole milk, 2% milk, 1% milk, skim milk, flavored milk (such as chocolate or strawberry milk); and other dairy product drinks, such as, for example and without limitation, yogurt drinks, including those sold by or under the name, for example and without limitation, Private Label®, Yoplait®, Dannon®, and Breyers®. Other drinks contemplated by the term “comestible liquids” include teas, such as those sold by or under the name, for example and without limitation, Arizona Iced Tea®, Nestea®, and Lipton® or other beverages, such as those marketed under the name Odwalla® or Yoohoo™. Comestible liquids also may include all soft drinks and caffeinated energy drinks as well as bottled coffees such as those sold by or under the name, for example and without limitation, Starbucks' Frappucino™ and Chantico®.

The phrase “standard externally-threaded neck” refers to the area containing screw threads surrounding and immediately below (typically approximately 0-30 mm) the mouth opening of a bottle through which a comestible liquid may be drank or poured. Standard neck diameter sizes include 18 mm, 20 mm, 22 mm, 24 mm, 26 mm, 28 mm, 33 mm, 38 mm, 43 mm, 48 mm, 53 mm, 63 mm, 70 mm, 89 mm, and 110 mm. (See, for example, www.plasticbottle.com/productlines/closures.html (last visited Oct. 17, 2004), www.plasticbottle.com/productlines/carafe.html (last visited Oct. 17, 2004), www.plasticbottle.com/productlines/lawn.html (last visited Oct. 17, 2004), www.plasticbottle.com/productlines/cosmetics.html (last visited Oct. 17, 2004), www.plasticbottle.com/productlines/autoadd.html (last visited Oct. 17, 2004), www.plasticbottle.com/productlines/autoapp.html (last visited Oct. 17, 2004), www.plasticbottle.com/productlines/house.html (last visited Oct. 17, 2004), www.plasticbottle.com/productlines/spray.html (last visited Oct. 17, 2004), and www.plasticbottle.com/productlines/pet.html (last visited Oct. 17, 2004)). Standard neck finish numbers (representing screw thread configurations) include, 100, 110, 120, 140, 145, 100, 103, 200, 200A, 400, 410, 415, 425, 430, 435, 444, 445, 450, 455, 460, 470, 480, 485, 490, and 495. (See www.cmadc.org (last visited Oct. 17, 2004) and www.plasticbottle.com (last visited Oct. 17, 2004)). As is known to those of skill in art, these finish numbers also may include additional descriptive information to further refine the neck finish to which they refer. For instance, a standard-externally threaded neck may include such additional descriptors as, for example and without limitation, “tall,” “ramp,” “ratchet,” “anti-backoff” and “anti-rotational.” Thus, for purposes of the present invention, a “standard externally-threaded neck” is one having a diameter and finish number described above (e.g., 28-400; 33-425 or any other appropriate combination) with or without an additional descriptor.

The phrase “bottle containing a comestible liquid” refers to any container that contains or is capable of containing a comestible liquid and has a standard externally-threaded neck. As long as the bottle meets the above requirements, it may be made of any material, such as, for example and without limitation, glass, plastics, and metals, such as, for example and without limitation, aluminum.

The term “baby” is used synonymously with “infant.” In addition to the commonly understood meaning of these terms, their use herein also may include all ages of children and adults. In addition to humans, the terms also may be interpreted to include non-human mammals and other animals, including, for example and without limitation, pets, farm animals, zoo animals and birds.

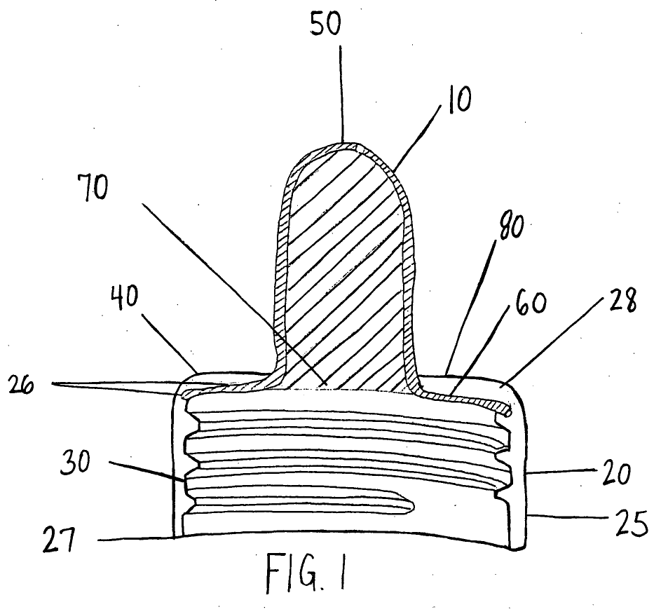

FIG. 1 through FIG. 7 depict exemplary nipple assemblies of the present invention. The nipple assemblies are depicted and described herein in order to better explain the invention. It will be understood that the nipple assemblies shown are representative only, and that nipple assemblies of other configurations, sizes and styles are within the scope of this invention. While the shape and dimension of the nipple assembly can vary as desired, in one embodiment, it is generally shaped to fit in the mouth of a young child of about 2 months to about four years of age.

Referring to the Figures, FIG. 1 depicts one embodiment of the nipple assembly of the present invention. From this Figure, it can be seen that the nipple assembly comprises a cap 20 and a nipple portion 10. The nipple assembly depicted in FIG. 1 allows a standard externally-threaded neck of a bottle containing a comestible liquid to be secured to a baby bottle nipple. This nipple assembly thus may receive the standard externally-threaded neck of a bottle containing a comestible liquid. When the nipple assembly cap 20 is screwed onto the exterior thread of a standard externally-threaded neck of a bottle, infants may directly obtain nourishment via the nipple assembly without the need to employ a baby bottle. The invention contemplates nipple assemblies comprising caps 20 sized to fit a large variety of standard externally-threaded necks found on bottles containing a comestible liquid. Thus, the dimensions of the nipple assembly cap 20 may vary as desired as long as it can be screwed onto a standard externally-threaded neck of a bottle containing a comestible liquid. Different embodiments of the cap 20 of the nipple assemblies of the present invention can screw specifically onto standard externally-threaded necks of bottles containing comestible liquids with standard externally-threaded neck diameters of about, for example and without limitation, 18 mm, 20 mm, 22 mm, 24 mm, 26 mm, 28 mm, 33 mm, 38 mm, 43 mm, 48 mm, 53 mm, 63 mm, 70 mm, 89 mm, and 110 mm and finish numbers of about, for example and without limitation, 100, 110, 120, 140, 145, 100, 103, 200, 200A, 400, 410, 415, 425, 430, 435, 444, 445, 450, 455, 460, 470, 480, 485, 490, and 495.

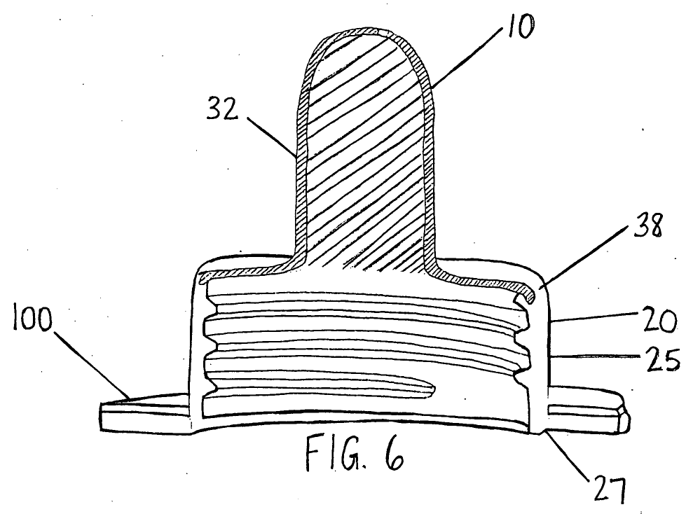

Referring to FIG. 1 and FIG. 6, it can be seen that the cap 20 comprises sides 25 and screw threads 30 on the inner surface 38 of the sides 25, a top portion 40, integral with said sides 25, with a hole 70 and a lip 80 and a bottom portion 27. The hole 70 is smaller than the circumference of the sides 25 thereby creating a lip 80 that extends inwards from the sides 25 of the cap 20 towards the center of the cap 20 and integral thereto.

The nipple portion 10 comprises a nipple 50 and a base 60. The base 60 is sized such that it fits securely within the hole 70 in the top 40 of the cap 20 as well as the sides 25 of the cap 20. This secure and snug fit of the base 60 of the nipple portion 10 mechanically anchors the nipple portion 10 within the cap 20. In this configuration, the base 60 of the nipple portion 10 abuts the bottom surface 26 of the lip 80 of the cap 20 as well as the top portion of the interior surface 38 of the sides 25 of the cap 20. In this configuration, a seal is formed when a standard externally-threaded neck of a bottle containing a comestible liquid is screwed into the cap 20, such that the top of the mouth opening of the bottle presses the base 60 of the nipple portion 10 up against the bottom surface 26 of the lip 80 of the top 40 of the cap 20. This seal helps to prevent leakage during use. In one particular embodiment this seal may be a liquid impermeable seal. In another particular embodiment, the seal may be an airtight seal.

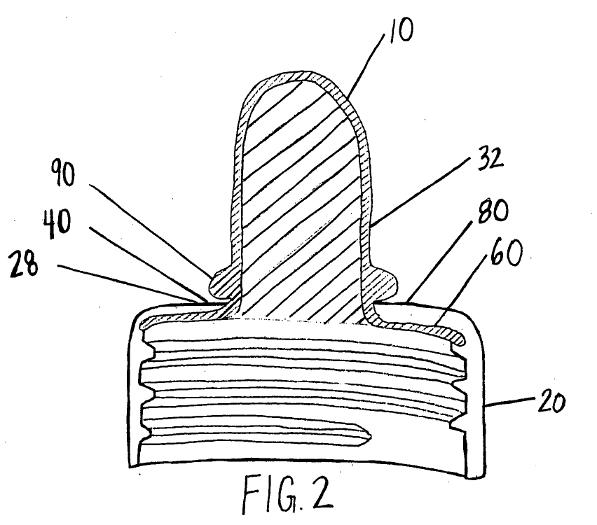

Turning to FIG. 2, the nipple assembly of the present invention may also comprise a protrusion 90 extending radially outwardly from the surface of the nipple portion 10 above the upper surface 28 of the lip 80 of the top 40 of the cap 20. In one embodiment, this protrusion 90 may be immediately above and abutting the upper surface 28 of the lip 80 of the top 40 of the cap 20. The protrusion 90 may serve to further mechanically anchor the base 60 of the nipple portion 10 of the nipple assembly within the cap 20 by preferably forming a mechanical association with the upper surface 28 of the lip 80 of the top 40 of the cap 20. This protrusion is preferably made of the same material and is continuous with the shaft 32 of the nipple portion 10.

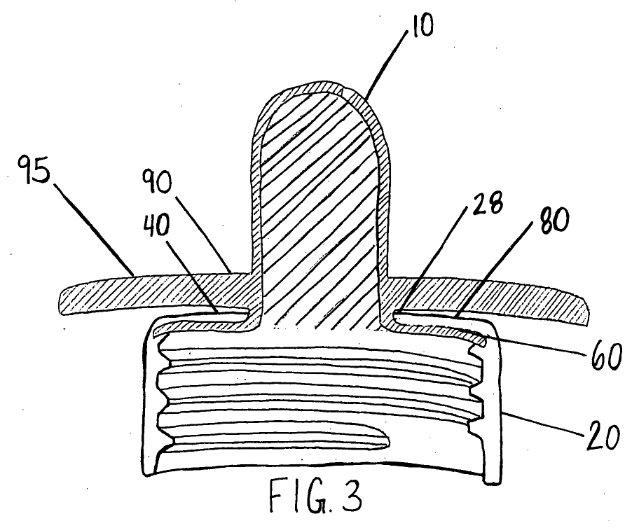

Referring to FIG. 3, in an alternative embodiment, the nipple protrusion 90 alternatively constitutes an enlarged collar 95 radially extending outwardly from the nipple portion 10 that serves to further mechanically anchor the nipple portion 10 of the nipple assembly within the cap 20 by forming a mechanical association with the upper surface 28 of the lip 80 of the top 40 of the cap 20. In addition, this particular embodiment of the nipple protrusion also mechanically may prevent the standard externally-threaded neck or other portions of the bottle containing a comestible liquid from falling into a baby's mouth. In one particular embodiment, this enlarged collar 95 may be a radially-enlarged annular flange. In another particular embodiment, the enlarged collar 95 may have a diameter of at least about 38 mm. In another particular embodiment, the enlarged collar may have a diameter of at least about 40 mm. In yet another particular embodiment, the enlarged collar may have a diameter of at least about 45 mm. It should be realized that while the enlarged collar 95 is depicted as a radially-enlarged annular flange, this collar 95 may take any shape that mechanically prevents the standard externally-threaded neck or other portion of a bottle containing a comestible liquid from falling into the mouth of a baby.

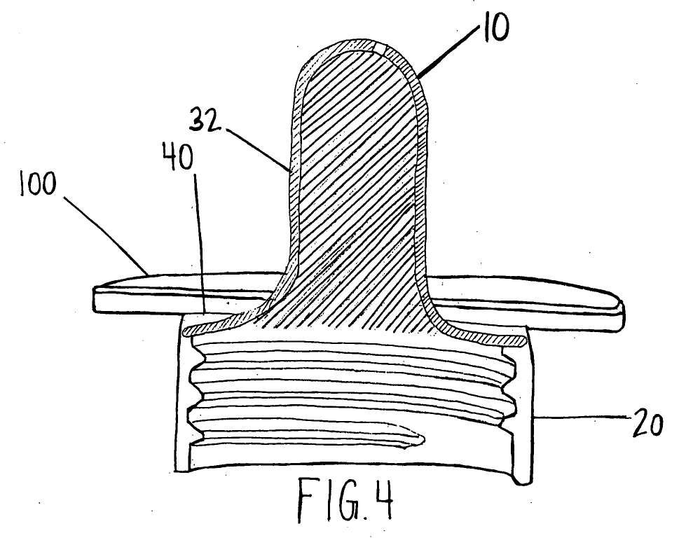

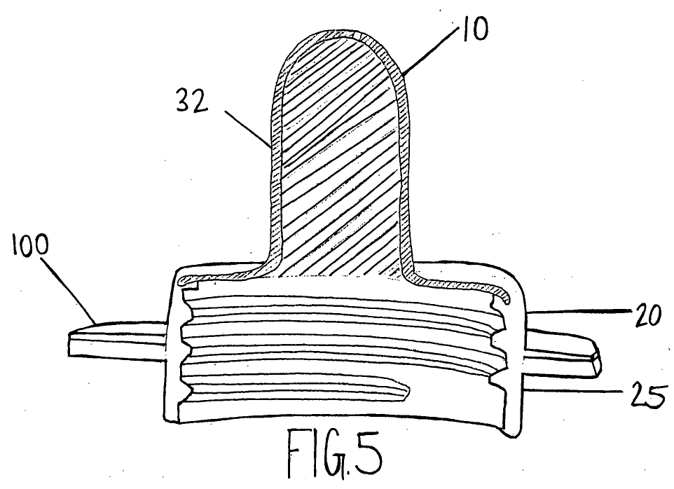

FIG. 4 through FIG. 6 depict further alternative embodiments of the nipple assembly of the present invention. In these embodiments, the nipple assembly includes a different embodiment of an enlarged collar 100 that extends outwards from the cap 20 rather than from the shaft 32 of the nipple portion 10. This enlarged collar 100 may extend from the top 40 of the cap 20 (FIG. 4), the outer surface of the sides 25 of the cap 20 (FIG. 5) or the bottom portion 27 of the sides 25 of the cap 20 (FIG. 6). In one embodiment the enlarged collar 100 may be manufactured as an integral and continuous part of the cap 20. In this embodiment, it is contemplated that the enlarged collar 100 and cap 20 are manufactured out of the same material. In another embodiment, the enlarged collar 100 may be attached to the cap 20 separately by mechanical or frictional forces. In this embodiment, the enlarged collar 100 and cap 20 may be manufactured out of the same, similar or different materials. In another alternative embodiment, the enlarged collar 100 may have a diameter of at least about 38 mm. In another embodiment, the enlarged collar 100 may have a diameter of at least about 40 mm. In a further particular embodiment, the enlarged collar 100 may have a diameter of at least about 45 mm. It should be realized that while the enlarged collars 100 are depicted in the Figures as radially-enlarged annular flanges, these collars 100 may take any shape that mechanically prevents the standard externally-threaded neck or other portion of a bottle containing a comestible liquid from falling into the mouth of a baby.

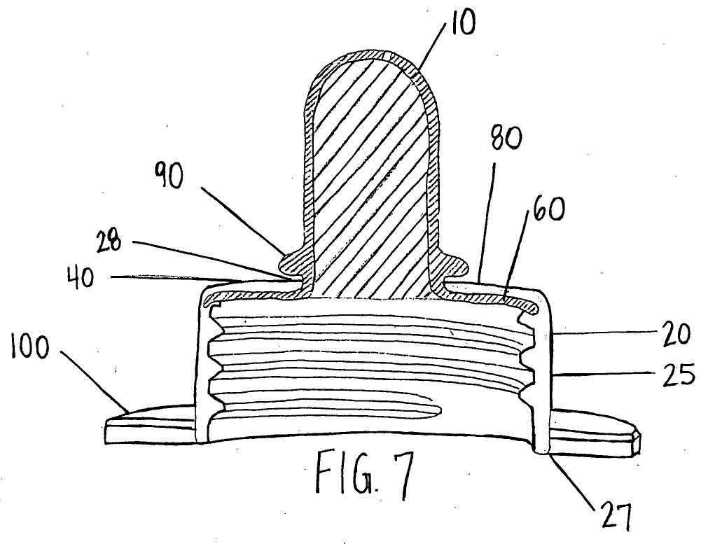

FIG. 7 demonstrates another alternative embodiment of the nipple assembly of the present invention. In this embodiment, the cap 20 includes an enlarged collar 100, extending from the bottom portion 27 of the sides 25 of the cap 20 that is capable of mechanically preventing the standard externally-threaded neck or other portion of a bottle containing a comestible liquid from falling into a baby's mouth. This embodiment also includes a protrusion 90 extending radially outwardly from the surface of the nipple portion 10 above the upper surface 28 of the lip 80 of the top 40 of the cap 20. This protrusion 90 may serve to further mechanically anchor the base 60 of the nipple portion 10 of the nipple assembly within the cap 20 by preferably forming a mechanical association with the upper surface 28 of the lip 80 of the top 40 of the cap 20. While it is preferred that the protrusion 90 and the upper surface 28 of the lip 80 of the top 40 of the cap 20 form a mechanical association, other embodiments where no such association is formed are contemplated. Indeed, this protrusion 90 may be placed closer to the nipple 50 of the nipple portion 10 as long as its placement does not interfere with an infant's ability to drink from the nipple assembly. Again, this protrusion is preferably made of the same material and is continuous with the shaft 32 of the nipple portion 10. Thus, this embodiment includes the enlarged collar 100 extending from the cap 20 as depicted in FIG. 4 through FIG. 6 as well as the nipple protrusion 90 initially depicted in FIG. 2.

In one embodiment of the invention, the nipple portion 10 and the cap 20 may be held together as a unitary assembly by purely mechanical forces. When the nipple portion 10 and the cap 20 are held together by purely mechanical forces, these two components of the nipple assembly may be separated without damaging either. However, it is contemplated that they will remain as an integral unit for the duration of their use. In other embodiments, the nipple portion 10 and the cap 20 may be bound into a unitary assembly by other ways. For example, the base 60 of the nipple portion 10 may be affixed to the top portion of the interior surface 38 of the sides 25 of the cap 20 with a non-toxic glue or adhesive. Alternatively, the base 60 of the nipple portion 10 may be affixed to the top portion of the interior surface 38 of the sides 25 of the cap 20 by heat sealing. The base 60 of the nipple portion 10 and the top portion of the interior surface 38 of the sides 25 of the cap 20 may also be bonded together during the hardening of materials during manufacturing. When the nipple portion 10 and the cap 20 are bound into a unitary assembly, the nipple portion 10 preferably is permanently and non-removably affixed to the cap 20.

Regardless of whether the nipple portion 10 and the cap 20 are mechanically affixed or permanently affixed with the use of adhesive or bonding, the nipple assembly preferably is provided pre-assembled as a kit including a unitary assembly to the end user. In such an embodiment, the nipple assembly of the present invention requires no assembly by the end user and use is accomplished simply by removing the cap of a bottle containing a comestible liquid and replacing it with the nipple assembly of the present invention. Other kit assemblies are contemplated by the present invention. For instance, in one embodiment of a kit, various sizes and embodiments of the nipple assemblies of the present invention are included and sold in multi-packs. In another kit embodiment, the kit may contain a single nipple assembly. In yet another embodiment, a kit may contain multiple nipple assemblies of a uniform or varying size and embodiment. Further, it is contemplated that the nipple assemblies of the present invention may be sold as a kit including a nipple assembly in conjunction with an appropriately-sized bottle for the particular embodiment and a powdered baby formula. In another embodiment, the kit may contain nipple assemblies of various sizes and embodiments with appropriately-sized bottles for the particular included nipple assembly embodiments along with an appropriate number of packets of powdered baby formula (for example and without limitation, one packet of powdered baby formula per bottle and nipple assembly). It is also contemplated that the caps of the nipple assemblies of the present invention may be manufactured as child-resistant or child-proof caps.

The cap 20 and the enlarged collar 100 extending from the cap 20 of the present invention may be fabricated from readily available materials by conventional fabrication techniques. For example, the cap 20 and the enlarged collar 100 may be made of plastic and may be fabricated by plastic molding as well as by conventional material bonding and assembly methods such as by the use of adhesives and by heat seal welding.

The nipple portions of the present invention preferably may be generally conical-shaped with a flexible tubular body. They preferably may be made out of a polymer that permits a baby to deform elastically and displace the nipple about one-half inch to either side. The nipple also, however, may be substantially solid such that a baby or young child can not readily bite or bend the nipple to constrict apertures and prevent fluid from flowing through the apertures. To achieve these characteristics, the nipple preferably may be made of a flexible, elastomeric material of a type commonly employed in the manufacture of infant-feeding nipples, e.g., silicone or rubber, a suitable synthetic substitute, and the like.

Finally, the nipple assembly of the present invention may be constructed in a wide variety of sizes, colors and style variations and may also have artistic decorations (not shown) thereon. Regardless of size, color, style variation or presence of artistic decorations, the nipple assembly of the present invention may be readily adapted to fit the standard externally-threaded necks of bottles containing comestible liquids. It is also contemplated that the various sizes and embodiments of the present invention be sold in multi-packs of varying combinations.

The foregoing is considered as illustrative only of the principles of the presently disclosed nipple assemblies of the present invention. Because numerous modifications and changes will readily occur to those skilled in the art, the foregoing is not intended to limit the invention to the exact construction and operation shown and described. Accordingly, all suitable modifications and equivalents are included as falling within the scope of the invention.

I claim:

1. A nipple assembly comprising a cap portion and a nipple portion, wherein said cap portion comprises sides and a top, and wherein said sides have an inner surface comprising screw threads and said top has a hole that is smaller than the circumference of the sides and a lip portion extending inwards from the sides towards the center of said cap, and wherein said nipple portion comprises a nipple and a base wherein said base fits securely within said hole in said top and said sides of said cap such that the base portion of said nipple mechanically anchors said nipple within said cap and wherein said base mechanically abuts the bottom surface of said lip such that when said cap is screwed onto a standard externally-threaded neck of a bottle containing a comestible liquid, said base acts to form a seal between said bottom surface of said cap and the top of said bottle, and wherein said standard externally-threaded neck has a diameter selected from the group consisting of 18 mm, 20 mm, 22 mm, 24 mm, 26 mm, 28 mm, 33 mm, 38 mm, 43 mm, 48 mm, 53 mm, 63 mm, 70 mm, 89 mm, and 110 mm.

2. The nipple assembly of claim 1, wherein said standard externally-threaded neck has a finish number selected from the group consisting of 100, 110, 120, 140, 145, 100, 103, 200, 200A, 400, 410, 415, 425, 430, 435, 444, 445, 450, 455, 460, 470, 480, 485, 490, and 495.

3. The nipple assembly of claim 1, wherein said nipple further includes a protrusion extending outwardly from said nipple above the top portion of said lip of said cap, serving to further mechanically anchor said nipple within said cap.

4. The nipple assembly of claim 1, further comprising an outwardly extending collar capable of mechanically preventing said standard externally-threaded neck or other portion of said bottle containing said comestible liquid from falling into a baby's mouth.

5. The nipple assembly of claim 4, wherein said outwardly extending collar is a radially-enlarged annular flange.

6. The nipple assembly of claim 4, wherein said collar has a diameter of at least about 38 millimeters.

7. The nipple assembly of claim 4, wherein said collar has a diameter of at least about 40 millimeters.

8. The nipple assembly of claim 4, wherein said collar has a diameter of at least about 45 millimeters.

9. The nipple assembly of claim 1, wherein said nipple comprises a protrusion extending outward from said nipple above the top portion of said lip portion of said cap, serving to further mechanically anchor said nipple within said cap and further comprising an outwardly extending collar from said cap capable of preventing said standard externally-threaded neck or other portion of said bottle containing said comestible liquid from falling into a baby's mouth.

10. The nipple assembly of claim 3, wherein said nipple protrusion comprises an enlarged collar capable of further mechanically anchoring said nipple within said cap and of preventing said standard externally-threaded neck or other portion of said bottle containing said comestible liquid from falling into a baby's mouth.

11. The nipple assembly of claim 10, wherein said enlarged collar portion comprises a radially-enlarged annular flange.

12. The nipple assembly of claim 4, wherein said collar extends outwardly from said cap.

13. The nipple assembly of claim 12, wherein said collar and said cap are molded as one piece during manufacturing.

14. The nipple assembly of claim 12, wherein said collar and said cap are held together by frictional forces.

15. The nipple assembly of claim 12, wherein said collar extends outwardly from said top portion of said cap.

16. The nipple assembly of claim 15, wherein said collar is a radially-enlarged annular flange.

17. The nipple assembly of claim 12, wherein said collar extends outwardly from said sides of said cap.

18. The nipple assembly of claim 17, wherein said collar is a radially-enlarged annular flange.

19. The nipple assembly of claim 12, wherein said collar extends outwardly from the bottom portion of said cap.

20. The nipple assembly of claim 19, wherein said collar is a radially-enlarged annular flange.

21. The nipple assembly of claim 9, wherein said collar extends outwardly from said top portion of said cap.

22. The nipple assembly of claim 9, wherein said collar extends outwardly from said sides of said cap.

23. The nipple assembly of claim 9, wherein said collar extends outwardly from said bottom portion of said cap.

24. The nipple assembly of claim 1, wherein said comestible liquid is selected from the group consisting of water, milk, tea, juice, sports drinks, soft drinks and yogurt drinks.

25. The nipple assembly of claim 1, wherein said nipple is generally conical-shaped with a flexible tubular body.

26. The nipple assembly of claim 1, wherein said nipple and cap are a unitary assembly.

27. The unitary nipple assembly of claim 26, wherein said nipple and said cap are bound together with a glue or adhesive.

28. The unitary nipple assembly of claim 27, wherein said glue or adhesive is non-toxic.

29. The unitary nipple assembly of claim 26, wherein said nipple and said cap are bound together by heat sealing.

30. The unitary nipple assembly of claim 26, wherein said nipple and said cap are bonded together during the hardening of the materials during manufacturing.

31. The nipple assembly of claim 1, wherein said nipple and said cap may be separated into two pieces.

32. The nipple assembly of claim 9, having no additional parts.

33. The nipple assembly of claim 9, having no additional functions.
